(19) United States
(12) Patent Application Publication
(10) Pub. No.: US 2025/0200061 A1
(43) Pub. Date: Jun. 19, 2025

(54) METHOD FOR DISPLAYING SEARCH RESULT, ELECTRONIC DEVICE AND STORAGE MEDIUM

(71) Applicant: Beijing Zitiao Network Technology Co., Ltd., Beijing (CN)

(72) Inventors: Tingting ZOU, Beijing (CN); Shuangshuang JIANG, Beijing (CN); Yating LIN, Beijing (CN)

(21) Appl. No.: 19/069,129

(22) Filed: Mar. 3, 2025

Related U.S. Application Data
(63) Continuation of application No. PCT/CN2024/080033, filed on Mar. 5, 2024.

(30) Foreign Application Priority Data
Mar. 6, 2023 (CN) 202310210485.6

(51) Int. Cl. G06F 16/248

(52) U.S. Cl. CPC G06F 16/248

(57) ABSTRACT

The present disclosure provides a method for displaying search result, an electronic device, and a storage medium. The method includes: performing, according to a received query request, demand analysis to obtain a demand analysis result; performing, according to the demand analysis result and the query request, a search to obtain an initial search result; determining, according to the demand analysis result and the initial search result, first display information; determining, according to the first display information, second display information associated with the first display information; and displaying, at a preset position of a display interface, the first display information, and displaying, next to the first display information, the second display information. The present disclosure can improve the efficiency of a user browsing information and enhance the experience of the user.

### CROSS-REFERENCE TO RELATED APPLICATION

This application is a continuation of International Application No. PCT/CN2024/080033, filed on Mar. 5, 2024, which claims priority to and benefits of Chinese Patent Application No. 202310210485.6, filed on Mar. 6, 2023. All of aforementioned patent applications are incorporated herein by reference in their entireties.

### TECHNICAL FIELD

The present disclosure relates to a method for displaying search result an electronic device and a storage medium.

### BACKGROUND

In the search question and answer scenario, there are usually two types of user consumption manners: one is the come-and-go manner, in which the user exits the search after quick consumption; and the other is the deep consumption manner, in which after the first search and consumption is completed, the user initiates a search again to read related content. For the latter, the current consumption path is relatively long, requiring “clicking on a search details page-→consuming the details page-→returning to a search list page-→re-entering a search term-→re-filtering a related result and clicking to consume”, and thus, the user experience is relatively poor, and the search efficiency is relatively low.

### SUMMARY

Embodiments of the present disclosure provide a method for displaying search result, an apparatus, an electronic device and a storage medium.

An embodiment of the present disclosure provides a method for displaying search result. The method includes:
performing, according to a received query request, demand analysis to obtain a demand analysis result;
performing, according to the demand analysis result and the query request, a search to obtain an initial search result;
determining, according to the demand analysis result and the initial search result, first display information;
determining, according to the first display information, second display information associated with the first display information; and
displaying, at a preset position of a display interface, the first display information, and displaying, next to the first display information, the second display information.

An embodiment of the present disclosure provides a search result display apparatus. The search result display apparatus includes: a search module and a display module;
the search module is configured to perform, according to a received query request, demand analysis to obtain a demand analysis result, perform, according to the demand analysis result and the query request, a search to obtain an initial search result, determine, according to the demand analysis result and the initial search result, first display information, and determine, according to the first display information, second display information associated with the first display information; and
the display module is configured to display, at a preset position of a display interface, the first display information, and display, next to the first display information, the second display information.

An embodiment of the present disclosure provides an electronic device. The electronic device includes a memory, a processor, a bus, and a computer program stored in the memory and executable by the processor. The processor, when executing the computer program, performs the steps of the method for displaying search result described above.

An embodiment of the present disclosure provides a non-transitory computer-readable storage medium storing a computer program which, when executed by a processor, performs the steps of the method for displaying search result described above.

It is to be understood that the content described in this section is not intended to identify key or important features of the embodiments of the present disclosure, nor is it intended to limit the scope of the present disclosure. Other features of the present disclosure will become readily comprehensible through the following specification.

### BRIEF DESCRIPTION OF DRAWINGS

The drawings are used for better understanding of the solution, and are not intended to limit the present disclosure. The drawings are described below.

FIG. 1 is a schematic flowchart of a method for displaying search result according to a specific embodiment of the present disclosure.

FIG. 2 is a schematic diagram of an effect of a method for displaying search result according to a specific embodiment of the present disclosure.

FIG. 3 is a schematic diagram of an effect of a method for displaying search result according to another specific embodiment of the present disclosure.

FIG. 4 is a schematic structural diagram of a search result display apparatus according to a specific embodiment of the present disclosure.

FIG. 5 is a schematic structural diagram of an electronic device according to a specific embodiment of the present disclosure.

### DETAILED DESCRIPTION

It should be noted that the following detailed description is exemplary and is intended to further illustrate the present disclosure. Unless otherwise specified, all technical and scientific terms used herein have the same meanings as those commonly understood by those skilled in the art to which the present disclosure belongs.

It should be noted that the terms used herein are only for describing specific implementations, but are not intended to limit the exemplary implementations according to the present disclosure. As used herein, the singular forms are also intended to include the plural forms, unless the context clearly indicates otherwise. In addition, it should also be understood that when the terms “include/comprise” are used in the specification, they refer to the presence of features, steps, operations, devices, components, and/or combinations thereof.

The embodiments in the present disclosure and the features in the embodiments may be combined with each other without conflict.

To make the technical solutions and advantages of the present disclosure clearer, the present disclosure is further described in detail below with reference to the drawings and specific embodiments.

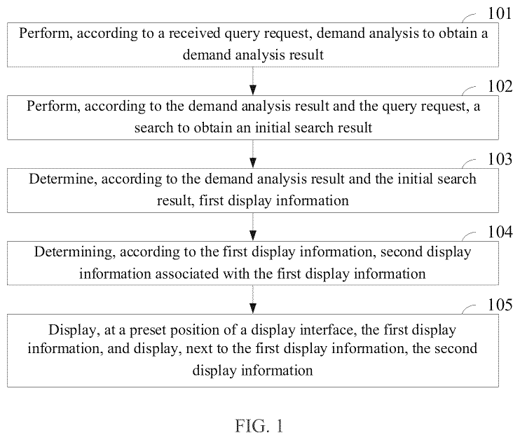

FIG. 1 is a flowchart of a search method according to a specific embodiment of the present disclosure. As shown in FIG. 1, a method for displaying search result according to a specific embodiment of the present disclosure includes the following steps.

Step 101: perform, according to a received query request, demand analysis to obtain a demand analysis result.

In a possible implementation of the present disclosure, when a user needs to perform a corresponding query, the user may send a corresponding query request.

For example, as an example, in a possible implementation of the present disclosure, the user may send the query request to a server through a client, or may directly input the query request on the server.

After receiving the query request, the demand analysis may be performed according to the query request to obtain the demand analysis result.

For example, as an example, in a possible implementation of the present disclosure, the demand analysis may be performed on the query request by using a method such as semantic understanding, semantic recognition, and/or a deep understanding model, to understand a specific demand in the query request (for example, determining that the query request is a question and answer demand), so as to obtain the corresponding demand analysis result.

Step 102: perform, according to the demand analysis result and the query request, a search to obtain an initial search result.

In the technical solution of the present disclosure, after obtaining the demand analysis result, the initial search may be further performed according to the demand analysis result and the query request, to obtain the corresponding initial search result.

For example, as an example, in a possible implementation of the present disclosure, the performing, according to the demand analysis result and the query request, a search to obtain an initial search result may include the following steps.

Step 211: determine, according to the demand analysis result and the query request, a search keyword.

In this step, after obtaining the demand analysis result, the specific demand in the query request (for example, the query request is a question and answer demand) may be learned according to the demand analysis result, and therefore the corresponding search keyword may be determined or extracted according to the demand analysis result and the query request.

Step 212: perform, according to the search keyword, a search to obtain the initial search result.

After obtaining the search keyword, the initial search may be performed according to the search keyword to obtain the corresponding initial search result.

For example, as an example, in a possible implementation of the present disclosure, if the query request is a question and answer demand, the corresponding search keyword may be determined according to the question and answer demand, and then matching is performed according to the determined search keyword to obtain the corresponding matching result, and the matching result is used as the initial search result.

Step 103: determine, according to the demand analysis result and the initial search result, first display information.

In the technical solution of the present disclosure, after obtaining the initial search result, the first display information may be determined according to the demand analysis result and the initial search result.

In addition, in the technical solution of the present disclosure, the first display information may be determined in various specific implementations.

For example, as an example, in a possible implementation of the present disclosure, the determining, according to the demand analysis result and the initial search result, first display information may be as follows:
when it is determined, according to the demand analysis result and the initial search result, that the query request has a definite answer, selecting N search results from the initial search result as the first display information, where N is a natural number.

For example, as an example, if the query request is a question and answer demand, the query request may have a definite answer (for example, having a unique answer, “yes” or “no”).

For example, it is assumed that the current query request is “The seven continents that the Earth's land is divided into are”. According to the demand analysis result, it may be learned that the query request is a question and answer demand, and the question to be queried is actually: Which continents are the Earth's land divided into? According to the initial search result, the query request has a definite answer: The seven continents that the Earth's land is divided into are Asia, Europe, North America, South America, Africa, Oceania, and Antarctica (which is equivalent to “having an affirmative answer”).

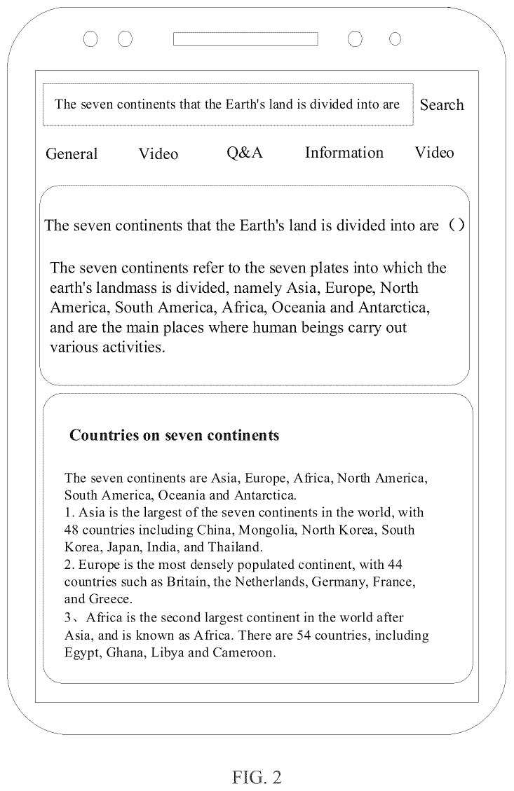

Therefore, N (for example, the first) search results may be selected from the initial search result as the first display information, as shown in the upper part of FIG. 2.

For another example, as an example, in a possible implementation of the present disclosure, the determining, according to the demand analysis result and the initial search result, first display information may also be as follows:
when it is determined, according to the demand analysis result and the initial search result, that the query request does not have a definite answer, performing, according to the demand analysis result and the initial search result, an extended search to obtain an extended search result; and
using the first N search results in the extended search result as the first display information, where N is a natural number.

For example, as an example, if the query request is a question and answer demand, the query request may not have a definite answer (for example, the answer does not exist or is not unique).

For example, it is assumed that the current query request is: “How much does a second-hand of XX model host cost”. According to the demand analysis result, it may be learned that the query request is a question and answer demand. According to the initial search result, the query request does not have a definite answer, for example, the price of the second-hand host of “XX” is not searched out, which is equivalent to that the answer does not exist.

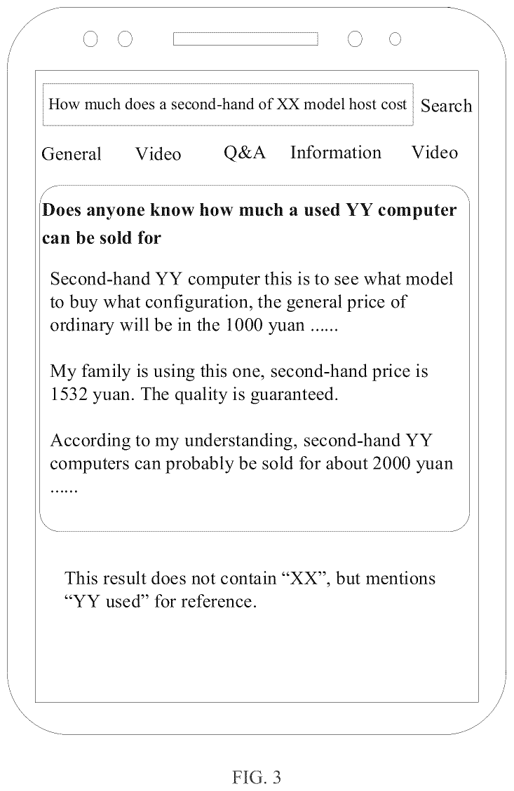

Therefore, the extended search may be further performed according to the demand analysis result and the initial search result to obtain the extended search result, and the first N (for example, the first) search results in the extended search result are used as the first display information, as shown in the upper part of FIG. 3.

In addition, in the technical solution of the present disclosure, the above extended search may be performed in various specific implementations.

For example, as an example, in a possible implementation of the present disclosure, the performing, according to the demand analysis result and the initial search result, an extended search to obtain an extended search result may include the following steps.

Calculating, based on the demand analysis result and the first display information, at least one of entity word relevance and similarity, to determine at least one of a corresponding extended keyword and a relationship chain; and
performing, according to at least one of the extended keyword and the relationship chain, the extended search to obtain the extended search result.

In the above possible implementation of the present disclosure, the extended search result may be obtained by referring to search results obtained by other users after obtaining the initial search result, based on the demand analysis result and the initial search result; or by linking some other key chains or key information through calculation such as entity word relevance and/or similarity calculation.

In addition, in the technical solution of the present disclosure, the N search results may be selected from the initial search result or the extended search result in various specific implementations. For example, as an example, in a possible implementation of the present disclosure, a sorting algorithm (for example, full-text understanding, answer voting, or the like) may be used to sort the initial search result or the extended search result, and the first N search results after sorting are used as the first display information.

In addition, in the technical solution of the present disclosure, the value of N may be preset according to requirements of an actual application scenario. For example, as an example, in a possible implementation of the present disclosure, the value of N may be 1, 2, or 3, or may be another suitable value.

In addition, as an example, in a possible implementation of the present disclosure, whether the query request has a definite answer may be determined by the following method.

Semantic recognition is performed on the query request, and a demand of the query request is determined according to a result of the semantic recognition; and
whether the query request has a definite answer is determined according to the demand of the query request and the initial search result.

Step 104: determining, according to the first display information, second display information associated with the first display information.

In the technical solution of the present disclosure, after the first display information is determined, the second display information associated with the first display information may be determined according to the first display information.

In addition, in the technical solution of the present disclosure, the first display information may be determined in a variety of specific implementations.

For example, as an example, in a possible implementation of the present disclosure, the determining, according to the first display information, second display information associated with the first display information may include the following steps.

Step 411: when the query request has a definite answer, performing, according to the demand analysis result and the first display information, an extended search to obtain an extended search result.

In the technical solution of the present disclosure, when the query request has a definite answer (for example, having a unique answer, “yes” or “no”), the extended keyword may be determined according to the demand analysis result and the first display information, and then the extended search is performed according to the extended keyword, to obtain the extended search result.

Step 412: using the first M search results in the extended search result as the second display information, where M is a natural number.

In the technical solution of the present disclosure, after obtaining the extended search result, the first M search results in the extended search result may be used as the second display information.

In addition, in the technical solution of the present disclosure, the above extended search may be performed in various specific implementations.

For example, as an example, in a possible implementation of the present disclosure, the performing, according to the demand analysis result and the first display information, an extended search to obtain an extended search result may include the following steps.

Calculating, based on the demand analysis result and the initial search result, at least one of entity word relevance and similarity, to determine at least one of a corresponding extended keyword and a relationship chain; and
performing, according to at least one of the extended keyword and the relationship chain, the extended search to obtain the extended search result.

The above method of performing the extended search is similar to the method of performing the extended search according to the demand analysis result and the initial search result, and therefore reference may be made to the introduction in the previous embodiment, and details are not described herein again.

In addition, as an example, in a possible implementation of the present disclosure, when the query request has an affirmative answer, the second display information may be supplementary information related to the first display information;
while when the query request has a negative answer, the second display information may be a solution related to the first display information.

For example, it is assumed that the current query request is: “The seven continents that the Earth's land is divided into are”. The query request has an affirmative answer, and therefore the extended search may be performed according to the demand analysis result and the determined first display information to obtain the extended search result, and the first M (for example, the first) search results in the extended search result are used as the second display information. The second display information is equivalent to the supplementary information related to the first display information, and thus may provide a related reason, an authoritative signal, a useful comment, and the like for the first display information, so as to increase the confidence of the search result, as shown in the lower part of FIG. 2.

For another example, it is assumed that the current query request has a negative answer, and therefore the extended search may also be performed according to the demand analysis result and the determined first display information to obtain the extended search result, and the first M (for example, the first) search results in the extended search result are used as the second display information. The second display information is equivalent to the solution related to the first display information, and may provide a specific solution or suggestion on how to solve the problem for the user, so as to enable the user to obtain the corresponding solution while obtaining the negative answer, thereby improving the efficiency of the user browsing information and enhancing the corresponding experience.

In addition, as an example, in another possible implementation of the present disclosure, the determining, according to the first display information, second display information associated with the first display information may include:
when the query request does not have a definite answer, generating, according to the demand analysis result and the first display information, a key information prompt, and using the key information prompt as the second display information.

In the technical solution of the present disclosure, when the query request does not have a definite answer (for example, the answer does not exist or is not unique), the first display information may be selected from the extended search result first, and then the key information prompt is generated according to the demand analysis result and the first display information, and the key information prompt is used as the second display information.

For example, it is assumed that the current query request is: “How much does a second-hand of XX model host cost?”. The query request does not have a definite answer, and therefore after the first display information is determined, the key information prompt may be generated according to the demand analysis result and the first display information: “This result does not include ‘XX’, but the reference to ‘YY (a brand to which XX belongs) second-hand’ may be used as reference”, and the key information prompt is used as the second display information (equivalent to generating a prompt box with key information), to provide the user with related query clues to assist the user in making a judgment, so as to improve the efficiency of the user browsing information and enhance the corresponding experience, as shown in the lower part of FIG. 3.

In addition, in the technical solution of the present disclosure, the value of M may be preset according to requirements of an actual application scenario. For example, as an example, in a possible implementation of the present disclosure, the value of M may be 1, 2, or 3, or may be another suitable value.

Step 105: display, at a preset position of a display interface, the first display information, and display, next to the first display information, the second display information.

In the technical solution of the present disclosure, after obtaining the first display information and the second display information, the first display information may be displayed at the preset position of the display interface, and the second display information is displayed next to the first display information, as shown in FIG. 2, and FIG. 3.

Therefore, through the above steps 101 to 105, the search may be performed based on the query request of the user, and while providing the user with the answer related to the query request, the corresponding key information prompting (for example, information prompting such as a related reason, a message, a clue, a comment, a copy prompt, and a solution) may be further provided, so as to assist the user in obtaining more confident and comprehensive information, so that the user can obtain as much useful full-link content as possible in one search and consumption, thereby shortening the consumption path of the user and improving the efficiency of the user browsing information (the user does not need to repeatedly return to the search list page and initiate the search request again), thereby effectively enhancing the user experience.

In addition, in the technical solution of the present disclosure, a search result display apparatus is further provided.

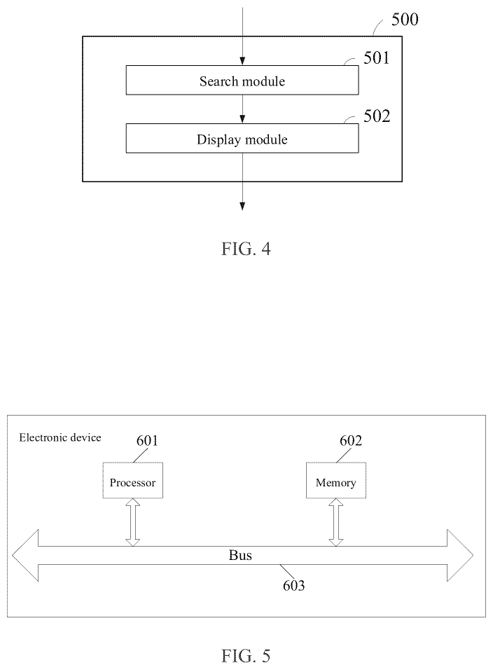

As shown in FIG. 4, a search result display apparatus 500 according to a specific embodiment of the present disclosure includes: a search module 501 and a display module 502;
the search module 501 is configured to perform, according to a received query request, demand analysis to obtain a demand analysis result, perform, according to the demand analysis result and the query request, a search to obtain an initial search result, determine, according to the demand analysis result and the initial search result, first display information, and determine, according to the first display information, second display information associated with the first display information; and
the display module 502 is configured to display, at a preset position of a display interface, the first display information, and display, next to the first display information, the second display information.

In addition, the search apparatus provided in the above embodiment of the present disclosure may be used to execute the technical solutions of the foregoing method embodiments, and the implementation principles and technical effects thereof are similar, which will not be described herein again.

FIG. 5 shows a schematic structural diagram of an electronic device according to an embodiment of the present disclosure.

As shown in FIG. 5, the electronic device may include a processor 601, a memory 602, a bus 603, and a computer program stored in the memory 602 and executable by the processor 601. The processor 601 and the memory 602 complete communication with each other through the bus 603. The processor 601, when executing the computer program, performs the steps of the above method for displaying search result, for example, including performing, according to a received query request, demand analysis to obtain a demand analysis result, performing, according to the demand analysis result and the query request, a search to obtain an initial search result, determining, according to the demand analysis result and the initial search result, first display information, determining, according to the first display information, second display information associated with the first display information, and displaying, at a preset position of a display interface, the first display information, and displaying, next to the first display information, the second display information.

In addition, an embodiment of the present disclosure further provides a non-transitory computer-readable storage medium storing a computer program which, when executed by a processor, performs the steps of the above method for displaying search result, for example, including performing, according to a received query request, demand analysis to obtain a demand analysis result, performing, according to the demand analysis result and the query request, a search to obtain an initial search result, determining, according to the demand analysis result and the initial search result, first display information, determining, according to the first display information, second display information associated with the first display information, and displaying, at a preset position of a display interface, the first display information, and displaying, next to the first display information, the second display information.

In conclusion, in the technical solution of the present disclosure, the demand analysis is performed according to the received query request to obtain the demand analysis result; the search is performed according to the demand analysis result and the query request to obtain the initial search result; the first display information is determined according to the demand analysis result and the initial search result; the second display information associated with the first display information is determined according to the first display information; the first display information is displayed at the preset position of the display interface, and the second display information is displayed next to the first display information. Therefore, the search may be performed based on the query request of the user, and while providing the user with the answer related to the query request, the corresponding key information prompting (for example, information prompting such as a related reason, a message, a clue, a comment, a copy prompt, and a solution) may be further provided, so as to assist the user in obtaining more confident and comprehensive information, so that the user can obtain as much useful full-link content as possible in one search and consumption, thereby shortening the consumption path of the user and improving the efficiency of the user browsing information (the user does not need to repeatedly return to the search list page and initiate the search request again), thereby effectively enhancing the user experience.

The above are only preferred embodiments of the present disclosure, and are not intended to limit the present disclosure. Any modification, equivalent replacement, improvement, etc. made within the spirit and principle of the present disclosure should be included in the protection scope of the present disclosure.

20. A method for displaying search result, comprising:
performing, according to a received query request, demand analysis to obtain a demand analysis result;
performing, according to the demand analysis result and the query request, a search to obtain an initial search result;
determining, according to the demand analysis result and the initial search result, first display information;
determining, according to the first display information, second display information associated with the first display information; and
displaying, at a preset position of a display interface, the first display information, and displaying, next to the first display information, the second display information.

2. The method according to claim 1, wherein the performing, according to the demand analysis result and the query request, a search to obtain an initial search result comprises:
determining, according to the demand analysis result and the query request, a search keyword; and
performing, according to the search keyword, a search to obtain the initial search result.

3. The method according to claim 1, wherein the determining, according to the demand analysis result and the initial search result, first display information comprises:
when it is determined, according to the demand analysis result and the initial search result, that the query request has a definite answer, selecting N search results from the initial search result as the first display information, wherein N is a natural number.

4. The method according to claim 3, wherein the determining, according to the first display information, second display information associated with the first display information comprises:
performing, according to the demand analysis result and the first display information, an extended search to obtain an extended search result; and
using first M search results in the extended search result as the second display information, wherein M is a natural number.

5. The method according to claim 4, wherein the performing, according to the demand analysis result and the first display information, an extended search to obtain an extended search result comprises:
calculating, based on the demand analysis result and the initial search result, at least one of entity word relevance and similarity, to determine at least one of a corresponding extended keyword and a relationship chain; and
performing, according to at least one of the extended keyword and the relationship chain, the extended search to obtain the extended search result.

6. The method according to claim 5, wherein:
in response to the query request having an affirmative answer, the second display information is supplementary information related to the first display information; and
in response to the query request having a negative answer, the second display information is a solution related to the first display information.

7. The method according to claim 1, wherein the determining, according to the demand analysis result and the initial search result, first display information comprises:
in response to determining, according to the demand analysis result and the initial search result, that the query request does not have a definite answer, performing, according to the demand analysis result and the initial search result, an extended search to obtain an extended search result; and
using the first N search results in the extended search result as the first display information, wherein N is a natural number.

8. The method according to claim 7, wherein the performing, according to the demand analysis result and the initial search result, an extended search to obtain an extended search result comprises:
calculating, based on the demand analysis result and the initial search result, at least one of entity word relevance and similarity, to determine at least one of a corresponding extended keyword and a relationship chain; and
performing, according to at least one of the extended keyword and the relationship chain, the extended search to obtain the extended search result.

9. The method according to claim 8, wherein the determining, according to the first display information, second display information associated with the first display information comprises:
generating, according to the demand analysis result and the first display information, a key information prompt, and using the key information prompt as the second display information.

10. The method according to claim 3, wherein whether the query request has the definite answer is determined by:
performing, a semantic recognition on the query request, and determining a demand of the query request according to a result of the semantic recognition; and
determining, according to the demand of the query request and the initial search result, whether the query request has the definite answer.

11. The method according to claim 7, wherein whether the query request has the definite answer is determined by:
performing, a semantic recognition on the query request, and determining a demand of the query request according to a result of the semantic recognition; and
determining, according to the demand of the query request and the initial search result, whether the query request has the definite answer.

12. An electronic device, comprising a memory, a processor, a bus, and a computer program stored in the memory and executable by the processor, wherein the processor, when executing the computer program, performs a method for displaying search result, and the method comprises:
performing, according to a received query request, demand analysis to obtain a demand analysis result;
performing, according to the demand analysis result and the query request, a search to obtain an initial search result;
determining, according to the demand analysis result and the initial search result, first display information;
determining, according to the first display information, second display information associated with the first display information; and
displaying, at a preset position of a display interface, the first display information, and displaying, next to the first display information, the second display information.

13. The electronic device according to claim 12, wherein the performing, according to the demand analysis result and the query request, a search to obtain an initial search result comprises:
determining, according to the demand analysis result and the query request, a search keyword; and
performing, according to the search keyword, a search to obtain the initial search result.

14. The electronic device according to claim 12, wherein the determining, according to the demand analysis result and the initial search result, first display information comprises:
in response to determining, according to the demand analysis result and the initial search result, that the query request has a definite answer, selecting N search results from the initial search result as the first display information, wherein N is a natural number.

15. The electronic device according to claim 14, wherein the determining, according to the first display information, second display information associated with the first display information comprises:
performing, according to the demand analysis result and the first display information, an extended search to obtain an extended search result; and
using first M search results in the extended search result as the second display information, wherein M is a natural number.

16. The electronic device according to claim 15, wherein the performing, according to the demand analysis result and the first display information, an extended search to obtain an extended search result comprises:
calculating, based on the demand analysis result and the initial search result, at least one of entity word relevance and similarity, to determine at least one of a corresponding extended keyword and a relationship chain; and
performing, according to at least one of the extended keyword and the relationship chain, the extended search to obtain the extended search result.

17. The electronic device according to claim 16, wherein:
in response to the query request having an affirmative answer, the second display information is supplementary information related to the first display information; and
in response to the query request having a negative answer, the second display information is a solution related to the first display information.

18. The electronic device according to claim 12, wherein the determining, according to the demand analysis result and the initial search result, first display information comprises:
in response to determining, according to the demand analysis result and the initial search result, that the query request does not have a definite answer, performing, according to the demand analysis result and the initial search result, an extended search to obtain an extended search result; and
using the first N search results in the extended search result as the first display information, wherein N is a natural number.

19. The electronic device according to claim 18, wherein the performing, according to the demand analysis result and the initial search result, an extended search to obtain an extended search result comprises:
calculating, based on the demand analysis result and the initial search result, at least one of entity word relevance and similarity, to determine at least one of a corresponding extended keyword and a relationship chain; and
performing, according to at least one of the extended keyword and the relationship chain, the extended search to obtain the extended search result.

20. A non-transitory computer-readable storage medium storing a computer program which, when executed by a processor, performs a method for displaying search result, and the method comprises:
performing, according to a received query request, demand analysis to obtain a demand analysis result;
performing, according to the demand analysis result and the query request, a search to obtain an initial search result;
determining, according to the demand analysis result and the initial search result, first display information;
determining, according to the first display information, second display information associated with the first display information; and
displaying, at a preset position of a display interface, the first display information, and displaying, next to the first display information, the second display information.
